(19) United States
(12) Patent Application Publication
(10) Pub. No.: US 2026/0225624 A1
(43) Pub. Date: Aug. 6, 2026

(54) DYNAMIC ATTRIBUTE GRID FORECASTING FOR AUTONOMOUS DRIVING

(71) Applicant: FCA US LLC, Auburn Hills, MI (US)

(72) Inventor: Peter R. Lengyel, Auburn Hills, MI (US)

(21) Appl. No.: 19/046,571

(22) Filed: Feb. 6, 2025

(51) Int. Cl. B60W 60/00; G06V 10/62; G06V 10/77; G06V 10/82; G06V 20/58

(52) U.S. Cl. CPC B60W 60/0027; G06V 10/62; G06V 10/7715; G06V 10/82; G06V 20/58; B60W 2420/403; B60W 2556/35

(57) ABSTRACT

A system and method for predicting a distribution of possible future object locations and associated attributes of objects surrounding a vehicle involve processing sensor data, including at least time-series image data, using a first neural network to fuse the sensor data and extract spatial features from the sensor data, processing the time-series image data using a primary recurrent neural network (RNN) to extract temporal features from the time-series image data, generating one or more future temporal features using a secondary RNN, applying a second neural network to the future temporal features to decode them into a model space representation, wherein the model space representation includes at least object occupancy and motion flow, and processing the model space representation to utilize it for at least one of controlling and influencing a vehicle control decision including at least one of ego-vehicle trajectory evaluation and exo-vehicle trajectory retrieval.

### FIELD

The present application generally relates to vehicle autonomous driving and, more particularly, to systems and methods for training a neural network to predict the future states of objects in a surrounding of a vehicle.

### BACKGROUND

A crucial ingredient of autonomous driving is the ability to build a 360-degree environment model. Conventional solutions solve this as a two-step process, where single sensor frames are processed by classical or learning based algorithms to extract object detections, after which the object detections are fused in time using some classical filtering algorithm. The deficiency of these conventional solutions is their representational limitations in modeling uncertainties caused by sensor and algorithmic shortcomings, information loss due to the use of thresholding, and the limited ability to utilize correlating information to reason about current and future attributes of dynamic objects (road markings, other objects, etc.). Accordingly, while such conventional autonomous driving systems suffice for their intended purpose, there exists an opportunity for improvement in the relevant art.

### SUMMARY

According to one example aspect of the invention, a system for predicting a distribution of possible future object locations and associated attributes of objects surrounding a vehicle is presented. In one exemplary implementation, the system comprises a set of one or more perception sensors configured to obtain sensor data that includes at least time-series image data and a control system configured to process the sensor data using a first neural network to fuse the sensor data and extract spatial features from the sensor data, process the time-series image data using a primary recurrent neural network (RNN) to extract temporal features from the time-series image data, generate one or more future temporal features using a secondary RNN, apply a second neural network to the future temporal features to decode them into a model space representation, wherein the model space representation includes at least object occupancy and motion flow, and process the model space representation to utilize it for at least one of controlling and influencing a vehicle control decision including at least one of ego-vehicle trajectory evaluation and exo-vehicle trajectory retrieval.

In some implementations, the time-series image data includes time-series spatial data that is processed by the primary RNN to extract spatio-temporal features. In some implementations, the spatio-temporal features are processed using the secondary RNN to generate one or more future state predictions, and wherein the one or more generated future state predictions are processed by the second neural network to generate model space attribute grids. In some implementations, the model space representation is a three-dimensional (3D) model space that comprises a bird's eye view raster. In some implementations, the primary and secondary RNNs are linked. In some implementations, the secondary RNN generates predictions in a different coordinate system than the primary RNN processes information from.

In some implementations, the primary RNN and the secondary RNN each comprise one of a convolutional recurrent neural network (CRNN), a convolutional gated recurrent unit (CGRU), and a convolutional long short-term memory (CLSTM). In some implementations, the primary and secondary RNNs form a coupled CLSTM (CCLSTM) module having primary and secondary CLSTM cells, and wherein the secondary CLSTM cell predicts at any integer multiple of the frame rate at which the primary CLSTM cell aggregates. In some implementations, the control system or a separate computing system is further configured to train the coupled CLSTM module. In some implementations, the vehicle control decision includes the control of a driver assistance or autonomous driving system based on the evaluation at least one of ego-vehicle and exo-vehicle trajectories based on the attribute grids.

According to another example aspect of the invention, a method for predicting a distribution of possible future object locations and associated attributes of objects surrounding a vehicle is presented. In one exemplary implementation, the method comprises obtaining, by a set of one or more perception sensors of the vehicle, sensor data that includes at least time-series image data, processing, by a control system of the vehicle, the sensor data using a first neural network to fuse the sensor data and extract spatial features from the sensor data, processing, by the control system, the time-series image data using a primary RNN to extract temporal features from the time-series image data, generating, by the control system, one or more future temporal features using a secondary RNN, applying, by the control system, a second neural network to the future temporal features to decode them into a model space representation, wherein the model space representation includes at least object occupancy and motion flow, and processing, by the control system, the model space representation to utilize it for at least one of controlling and influencing a vehicle control decision including at least one of ego-vehicle trajectory evaluation and exo-vehicle trajectory retrieval.

In some implementations, the time-series image data includes time-series spatial data that is processed by the primary RNN to extract spatio-temporal features. In some implementations, the spatio-temporal features are processed using the secondary RNN to generate one or more future state predictions, and wherein the one or more generated future state predictions are processed by the second neural network to generate model space attribute grids. In some implementations, the model space representation is a three-dimensional (3D) model space that comprises a bird's eye view raster. In some implementations, the primary and secondary RNNs are linked. In some implementations, the secondary RNN generates predictions in a different coordinate system than the primary RNN processes information from.

In some implementations, the primary RNN and the secondary RNN each comprise one of a CRNN, a CGRU, and a CLSTM. In some implementations, the primary and secondary RNNs form a coupled CLSTM (CCLSTM) module having primary and secondary CLSTM cells, and wherein the secondary CLSTM cell predicts at any integer multiple of the frame rate at which the primary CLSTM cell aggregates. In some implementations, the control system or a separate computing system is further configured to train the coupled CLSTM module. In some implementations, the vehicle control decision includes the control of a driver assistance or autonomous driving system based on the evaluation of at least one of ego-vehicle and exo-vehicle trajectories based on the attribute grids.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of a vehicle having an example autonomous driving system with a coupled convolutional long short-term memory (CCLSTM) module according to the principles of the present application;

FIGS. 2-3 are example network cell diagrams of for an example coupled CLSTM module of the autonomous driving system according to the principles of the present application; and

FIGS. 4A-4B are flow diagrams of an example vehicle autonomous driving method utilizing a coupled CLSTM module according to the principles of the present application.

### DESCRIPTION

As previously discussed, modelling of the future states of objects is vital for autonomous driving applications. Solutions currently in use solve this problem in a multiple step approach, where the future states are determined by one or more learning and classical based algorithms executed in parallel. This approach results in loss of information due to the modality changes between different algorithms and loss of information due to the heuristics and hyperparameters of each individual algorithm. This approach is also often used in a suboptimal configuration, as hyperparameters must be hand tuned. Further deficiencies of this approach are information loss due to limited ability to utilize correlating information to reason about current and future attributes.

One particular known solution to these problems is so called “end-to-end” networks. This learning-based approach allows all parameters of the perception to be optimized using data during training, resulting in higher data bandwidth for the data being processed, and a more optimal transformation of the data. Variants of the transformer neural network architecture are well suited to be used for this problem, however, this specific architecture is based on matrix multiplication operations, makes them challenging to execute on hardware optimized for other operations e.g. convolution operation. Furthermore, transformer architectures require significantly more data to train than convolution-based architectures.

Accordingly, embodiments of the present invention solve this problem by a novel end-to-end neural network architecture, which can be fully based on convolution operation. The main component of this architecture is two convolutional recurrent neural network (CRNN) cells, or a coupled CRNN (CCRNN). RNN cells are intended to process a sequence of vectors. CRNN cells are a variant of the original RNN cell architecture extending its use to a sequence of tensors. Linking two CRNN cells results in an architecture with components dedicated to learning and executing the accumulation of sensor data (primary CRNN cell) and forecasting of possible future states (secondary CRNN Cell). To be able to couple the two CRNN cells into the CCRNN, it is required for them to be of the same type of RNN with the same number of hidden states, be it a convolutional long short-term memory (CLSTM), a convolutional gated recurrent unit (GRU), or a basic CRNN.

Furthermore, this architecture is well suited to be deployed on neural processing units (NPUs) designed to run neural networks and, in particular, CNNs and RNNs. NPUs of existing vehicle controllers, for example, could otherwise be underutilized and thus could provide free (available) processing resources, thereby reducing the processing load on other processors (e.g., a central processing unit, or CPU, or graphical processing unit, or GPU). In execution, each update cycle, the primary cell receives the current sensor frame's 3D embedding tensor from an arbitrary neural net encoder. The primary cell updates one or more hidden states with the latest embedding tensor in an iterative process. This process results in one or more hidden states which contain the encoded spatio-temporal information required for forecasting.

Each update cycle, following the execution of the primary cell, the secondary cell's hidden state or states are initialized with a copy of the hidden state or states of that of the primary cell. The cell is then executed arbitrary times to produce a new hidden state or states. Each state produced in this way is an encoded representation of a future state with a fixed delta time difference between the states. This delta time can differ from that of the delta time of the primary cell, it can be of any duration for which training data exists or is created using e.g. interpolation of the label attributes to new data points. The sequence of predicted hidden states is then decoded to 3D model space by an arbitrary decoder network, usually a CNN. The coordinate system of the 3D model space can differ from that of the sensor space, it can be of any coordinate system for which training data exists or is created using geometrics transformation. The coupled CRNN cell is expected to learn this transformation in cycle time and space.

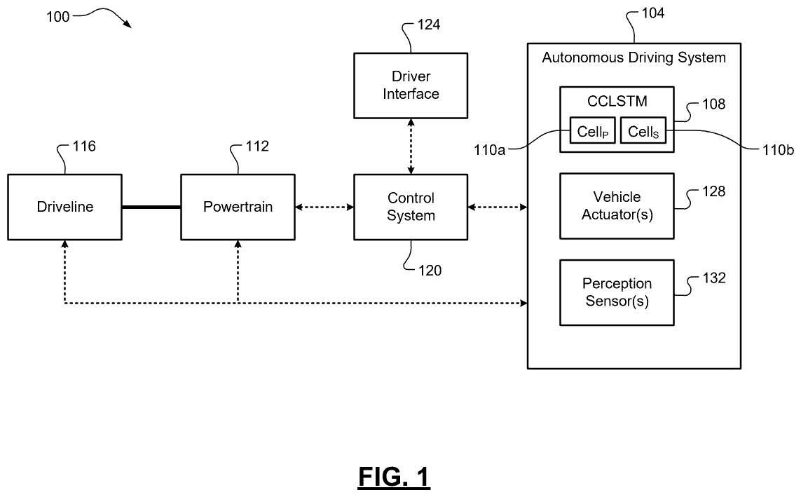

Referring now to FIG. 1, a functional block diagram of a vehicle 100 including an example autonomous driving system 104 having a coupled CLSTM neural network or module 108 according to the principles of the present application is illustrated. While a coupled two-cell CLSTM module 108 is shown and specifically discussed herein, it will be appreciated that this neural network or module 108 could be another type of coupled or linked multi (primary and secondary) CRNNs (CGRU, CLTSM, etc.). The vehicle 100 generally comprises a powertrain 112 (e.g., an engine, an electric motor, or some combination thereof) configured to generate and transfer torque to a driveline 116 (a differential, axles of half-shafts, wheels, etc.) for propulsion.

The vehicle 100 could be any suitable type of vehicle, including, but not limited to, a battery electric vehicle (BEV), a hybrid electric vehicle (HEV), or an internal combustion engine (ICE) only vehicle. A controller or control system 120 controls operation of the vehicle 100, which primarily involves controlling the powertrain 112 to generate a sufficient amount of torque to satisfy a driver torque request received via a driver interface 124 (e.g., an accelerator pedal). The vehicle 100 also includes the autonomous driving system 104, which includes a set of vehicle actuators 128 and a set of perception sensors 132. The autonomous driving system 104 also includes the coupled CLSTM module 108. While shown as being separate from the control system 120, it will be appreciated that the control system 120 could be part of the autonomous driving system 104 (e.g., to execute software to perform various autonomous driving features).

Non-limiting examples of the autonomous driving features performable by the autonomous driving system 104 include L0 (no autonomy) to L5 (full autonomy) features, such as automated emergency braking (AEB), adaptive cruise control (ACC), lane keeping/centering, automated lane changing, and fully-autonomous (“hands-free”) driving modes. The vehicle actuator(s) 128 include components such as an accelerator actuator, a brake actuator, and a steering actuator, and the like. The perception sensor(s) 132 include components such as one or more camera systems (a front-facing camera system, a surround camera system, etc.), a radio detection and ranging (RADAR) system, a light detection and ranging (LIDAR) system, motion sensors (speed, acceleration, etc.) and the like. The perception sensor(s) 132 can also include other conventional inertial sensors, such as position/speed/acceleration sensors and the like.

It will be appreciated that these are merely examples and that the autonomous driving system 104 could perform other autonomous driving features and/or could include other types of actuators/sensors. The coupled CLSTM module 108 is configured to be trained using training data indicative of real-world driving scenarios, which includes encountering various dynamic objects for detection and prediction. While object detection and prediction/tracking is specifically described herein, it will be appreciated that the coupled CLSTM module 108 could be applicable to other autonomous driving related tasks or features. The coupled CLSTM module 108 receives, from the set of perception sensors 132, input data that can be divided into a plurality of frames each spanning a period of time. For example only, the input data could include camera images, RADAR sensor data, and motion sensor data.

The CLSTM cells are composed of convolutional operations. For each frame of the input data, a primary CLSTM cell 110a of the coupled CLSTM module 108 accumulates the encoded spatial information of each new frame into its hidden and cell states. As discussed above, an LSTM is a type of RNN, and a CLSTM cell is the convolution operation-based version of original LSTM, more suited for processing spatial data. The coupled or CCLSTM module 108 is a combination of two CLSTM cells, linked and trained in such a way that it is capable of online accumulation and forecasting of model state space representations (grids) containing the attributes of objects surrounding the vehicle 100.

The primary CLSTM cell 110a, alternatively referred to as an accumulation CLSTM, is the part of the network architecture responsible for accumulating the past embeddings into a hidden and cell state embedding. A secondary or forecasting CLSTM cell 110b of the coupled CLSTM module 108 initializes each frame with the current hidden and cell states of the primary CLSTM cell 110a. Based on the states of the primary CLSTM cell 110a, the secondary or forecasting CLSTM 110b cell predicts one or more future frames in an auto-regressive manner. The secondary or forecasting CLSTM cell 110b is the part of the network architecture that autoregressively predicts future environment states based on the hidden and cell state embeddings of the primary CLSTM cell 110a. This results in limited spatial information fusion, making it difficult to fuse the temporal information of objects with large spatial offsets between frames. The coupled CLSTM module 108 turns a single input frame neural network (NN) into an RNN, giving it the ability to accumulate past information and predict the future state of the scene.

The primary and secondary cells 110a, 110b, using in conjunction with each other, can be utilized and trained in various manners, including, but not limited to: (i) training with different coordinate system outputs as that of the inputs; (ii) training with different prediction step size; and (iii) variable length number of predictions, where the number of predicted future frames can vary as needed. This training could be performed online at the vehicle 100 or, more ideally, offline by an external training computing system (e.g., having one or more high-performance GPUs). The predicted future attribute states are intended to be used as an interpretable representation of the scene on which the feasibility of trajectories can be evaluated. Test results show that it improves on the default networks current outputs and can further provide forecasted states.

The use of the coupled CLSTM module 108 also gives the neural network the ability to accumulate temporal information and predict future states, negating the current need to use a Kalman filter to post-process single frame detections. The model space representation could be, for example, an attribute grid (e.g., a three-dimensional, or 3D model space grid, such as a bird's eye view raster field) containing the attributes of objects surrounding the vehicle 100. The attribute grids are an extension of occupancy grids (or occupancy probably grids, indicating a value of a particular cell being occupied) and correspond to a cell of two-dimensional (2D) space surrounding the vehicle and contains some attribute of the object occupying it (class, velocity, forward/reverse motion flow, etc.). The forecasted grid states are to be used to evaluate the probability of a trajectory resulting in a collision with a dynamic object, which will be shown and also described in greater detail below.

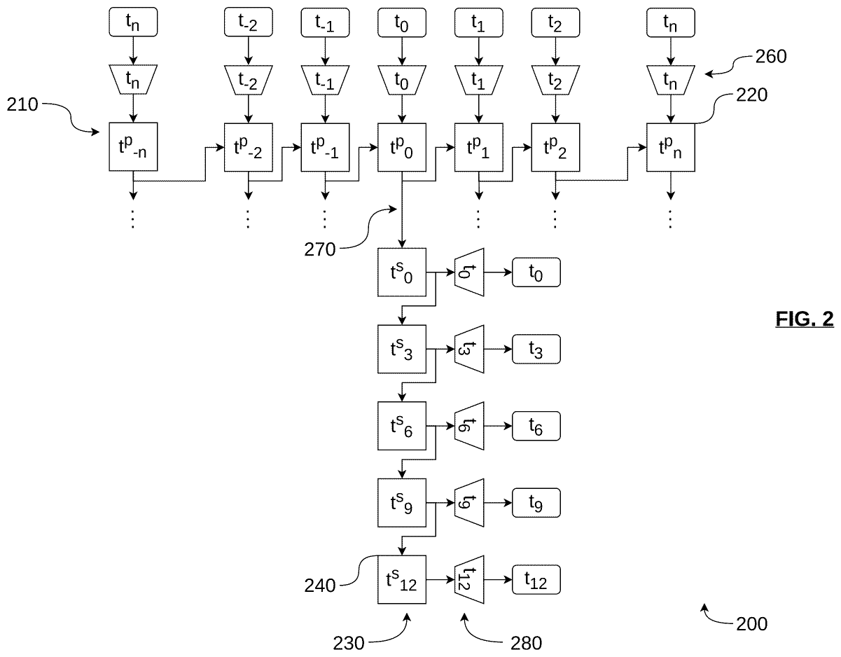

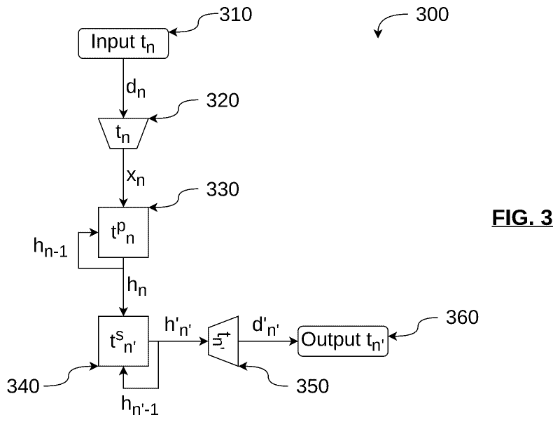

Referring now to FIGS. 2-3 and with continued reference to FIG. 1, example network cell diagrams 200, 300 of the coupled CLSTM module 108 according to the principles of the present application are illustrated. In FIG. 2, a network architecture 200 for the coupled CLSTM module 108 is generally divided into a primary CLSTM cell 210 that is responsible for accumulating past information. As shown, each frame 220 of the primary CLSTM cell 210 corresponds to a timestep for a defined frame rate (e.g., 15 frames per second, or ~66 milliseconds between frames). The frames are labeled (t−n) through (t+12), where n represents an integer value of a past or future frame. For each frame 220, a secondary forecasting CLSTM cell 230 initializes frame t of frames 240 with the current hidden and cell states of the primary CLSTM cell 210. An encoder neural network 260 is configured to encode or transform the input data (camera images, RADAR sensor data, motion sensor data, etc.) into a compressed representation (e.g., a 3D vector or tensor) for inclusion in the various frames 220 of the primary CLSTM cell 210.

The encoder neural network 260, for example, could utilize the same learned parameters or weights. As shown, each subsequent frame 220 of the primary CLSTM cell 210 is based on both the current (encoded) input data in addition to hidden and cell states from a previous frame 220. Based on the states of the primary CLSTM cell 210, the forecasting CLSTM cell 230 predicts one or more future frames 240 in an auto-regressive manner. As shown, each frame 240 of the forecasting CLSTM cell 230 corresponds to a timestep for a defined frame rate (e.g., 5 frames per second, or ~198 milliseconds between frames). The same hidden and cell states are also used to initialize the secondary forecasting CLSTM cell 230. The curved arrows represent the flow of data through the predicted/future cells. For example, this could be an arbitrary 3D tensor of shape (c, w, h). These are also known as “activations” or “latent embeddings”. The hidden and cell state are such tensors.

The prediction of frames 240 is performed in an auto-regressive manner and these predicted frames 240 (e.g., at current time t) are then provided to a decoder 280. The decoder 280 takes the compressed (e.g., 3D vector or tensor) representations of the data in the predicted frames 240 and transforms it into model space outputs (an occupancy grid, a motion flow field, etc.). The outputs are then utilized for object detection, which will have an improved accuracy compared to conventional systems due to the coupled CLSTM module 108 and its secondary forecasting CLSTM cell 230. FIG. 3 illustrates an example cell diagram 300 of the coupled CLSTM module 108 in operation to output or predict a state model representation 360 including one or more occupancy grids. Specifically, input 310 (tₙ) is provided as dₙ to encoder 320 and encoded input xₙ is provided to the primary CLSTM cell 330 (t^{p}ₙ). The primary CLSTM cell 330 uses previous hidden state hₙ₋₁ and generates hidden state hₙ. The secondary CLSTM cell 340 (t^{s}_{n′}) uses previous hidden state h_{n′-1} and generates hidden state h′_{n′}, which is provided to decoder 350 and decoded output d′_{n′} is provided as output 360 (t_{n′}).

In one exemplary embodiment, specific primary and secondary CLSTM equations could be utilized. For example, for the primary CLSTM, the following specific equations could be utilized:

$${f}_{t} = σ ( {W}_{t} * cat ( {X}_{t} , {H}_{t - 1} ) + {b}_{f} )$$

$${i}_{t} = σ ( {W}_{i} * cat ( {X}_{t} , {H}_{t - 1} ) + {b}_{i} )$$

$${g}_{t} = tanh ( {W}_{g} * cat ( {X}_{t} , {H}_{t - 1} ) + {b}_{g} )$$

$${o}_{t} = σ ( {W}_{o} * cat ( {X}_{t} , {H}_{t - 1} ) + {b}_{o} )$$

$${C}_{t} = {f}_{t} ∘ {C}_{t - 1} + {i}_{t} ∘ {g}_{t} , and$$

$${H}_{t} = {o}_{t} ∘ tanh ( {C}_{t} ) ,$$

where ○ denotes the Hadamand product and * denotes the convolutional operation, Hₜ is the hidden state at time t, and Cₜ is the cell state at time t, and where the remaining variables represent the functions, learned weights, and constants. Also for example, for the secondary CLSTM, the following specific equations could be utilized:

$${f}_{t} = σ ( {W}_{f} * {H}_{t - 1} + {b}_{f} )$$

$${i}_{t} = σ ( {W}_{i} * {H}_{t - 1} + {b}_{i} )$$

$${g}_{t} = tanh ( {W}_{g} * {H}_{t - 1} + {b}_{g} )$$

$${o}_{t} = σ ( {W}_{o} * {H}_{t - 1} + {b}_{o} )$$

$${C}_{t} = {f}_{t} ∘ {C}_{t - 1} + {i}_{t} ∘ {g}_{t} , and$$

$${H}_{t} = {o}_{t} ∘ tanh ( {C}_{t} ) .$$

In another exemplary embodiment, specific primary and secondary CGRU equations could be utilized. For example, for the primary CGRU, the following specific equations could be utilized:

$${z}_{t} = σ ( {W}_{z} * cat ( {X}_{t} , {H}_{t - 1} ) + {b}_{z} )$$

$${r}_{t} = σ ( {W}_{r} * cat ( {X}_{t} , {H}_{t - 1} ) + {b}_{r} )$$

$${h}_{t} = tanh ( {W}_{g} * cat ( {X}_{t} , cat ( {X}_{t} , {r}_{t} ∘ {H}_{t - 1} ) + {b}_{g} ) , and$$

$${H}_{t} = ( l - {z}_{t} ) ∘ {H}_{t - 1} + {z}_{t} ∘ {h}_{t} ,$$

where ○ denotes the Hadamand product and * denotes the convolutional operation, Xₜ is the input tensor, Hₜ is the hidden state at time t, and where the remaining variables represent the functions, learned weights, and constants. Also for example, for the secondary CGRU, the following specific equations could be utilized:

$${z}_{t} = σ ( {W}_{z} * {H}_{t - 1} + {b}_{z} )$$

$${r}_{t} = σ ( {W}_{r} * {H}_{t - 1} + {b}_{r} )$$

$${h}_{t} = tanh ( {W}_{g} * ( {r}_{t} ∘ {H}_{t - 1} ) + {b}_{g} ) , and$$

$${H}_{t} = ( l - {z}_{t} ) ∘ {H}_{t - 1} + {z}_{t} ∘ {h}_{t} .$$

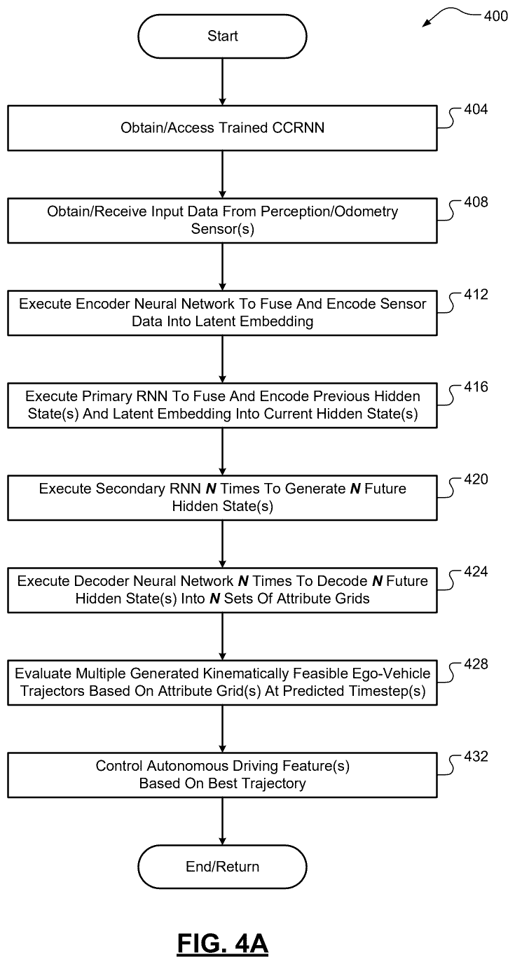

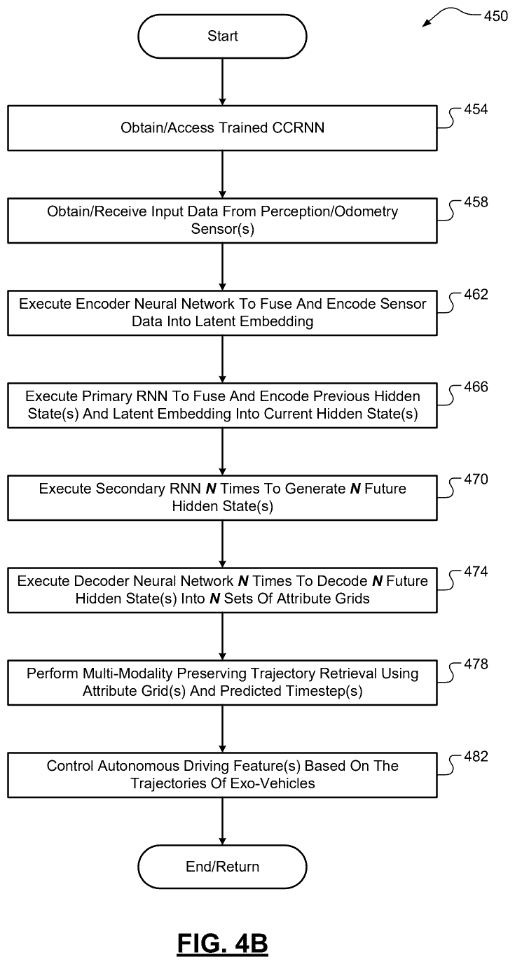

Referring now to FIGS. 4A-4B and with continued reference to the previous figures, flow diagrams example autonomous driving methods 400, 450 utilizing a coupled CLSTM module according to the principles of the present application are illustrated. While the vehicle 100 and its autonomous driving system 104 and coupled CLSTM module 108 are specifically referenced for descriptive/illustrative purposes, it will be appreciated that the methods 400, 450 could be applicable to any suitably configured vehicle having a suitably configured/trained coupled CLSTM module. It will be appreciated that methods 400 and 450 are the same (i.e., steps 404-424 and steps 454-474, respectively) except for final steps 428-432 and 478-482, which are different.

In FIG. 4A, the method 400 begins at 404 where the control system 120 obtains or accesses a trained CLSTM neural network or other suitable CCRNN neural network 108 having a coupled primary-secondary (forecasting) cell design. For example, the CLSTM neural network could have been previously generated and trained and stored in a memory of the control system 120. At 408, the control system 120 obtains input data for the CLSTM neural network 108 (e.g., from the perception sensor(s) 132). At 412, the control system 120 encodes input data 260 (camera images, RADAR sensor data, motion sensor data, etc.) using the encoder neural network 260 (e.g., a CNN or transformer network) into latent embeddings. At 416, the control system 120 executes a primary CRNN (the primary CLSTM cell 210) to fuse and encode previous hidden state(s) and the latent embeddings into current hidden state(s).

At 420, the control system 120 executes a secondary CRNN (the secondary/forecasting CLSTM cell 230) N times (where N is an integer greater than zero) to generate N future hidden state(s). At 424, the control system 120 executes the decoder neural network 280 (e.g., a CNN or transformer network) N times to decode the N future hidden state(s) into N sets of attribute grids. At 428, the control system 120 evaluates multiple generated (and kinematically feasible) ego-vehicle (for the vehicle 100) trajectories based on one or more of the attribute grids at one or more predicted timesteps. At 432, the control system 120 controls the autonomous driving system 104 based on a best trajectory from the generated (and kinematically feasible) ego-vehicle trajectories. The method 400 then ends or returns to 404 for one or more additional cycles.

In FIG. 4B, the method 450 begins at 454 where the control system 120 obtains or accesses a trained CLSTM neural network or other suitable CCRNN neural network 108 having a coupled primary-secondary (forecasting) cell design. For example, the CLSTM neural network could have been previously generated and trained and stored in a memory of the control system 120. At 458, the control system 120 obtains input data for the CLSTM neural network 108 (e.g., from the perception sensor(s) 132). At 462, the control system 120 encodes input data 260 (camera images, RADAR sensor data, motion sensor data, etc.) using the encoder neural network 260 (e.g., a CNN or transformer network) into latent embeddings. At 466, the control system 120 executes a primary CRNN (the primary CLSTM cell 210) to fuse and encode previous hidden state(s) and the latent embeddings into current hidden state(s).

At 470, the control system 120 executes a secondary CRNN (the secondary/forecasting CLSTM cell 230) N times (where N is an integer greater than zero) to generate N future hidden state(s). At 474, the control system 120 executes the decoder neural network 280 (e.g., a CNN or transformer network) N times to decode the N future hidden state(s) into N sets of attribute grids. At 478, the control system 120 performs multi-modality preserving trajectory retrieval using one or more of the attribute grids at one or more predicted timesteps. At 482, the control system 120 controls the autonomous driving system 104 based on the trajectories of exo-vehicles (i.e., other vehicles than the vehicle 100). The method 450 then ends or returns to 404 for one or more additional cycles.

It will be appreciated that the terms “controller” and “control system” as used herein refer to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A system for predicting a distribution of possible future object locations and associated attributes of objects surrounding a vehicle, the system comprising:
a set of one or more perception sensors configured to obtain sensor data that includes at least time-series image data; and
a control system configured to:
process the sensor data using a first neural network to fuse the sensor data and extract spatial features from the sensor data;
process the time-series image data using a primary recurrent neural network (RNN) to extract temporal features from the time-series image data;
generate one or more future temporal features using a secondary RNN;
apply a second neural network to the future temporal features to decode them into a model space representation, wherein the model space representation includes at least object occupancy and motion flow; and
process the model space representation to utilize it for at least one of controlling and influencing a vehicle control decision including at least one of ego-vehicle trajectory evaluation and exo-vehicle trajectory retrieval.

2. The system of claim 1, wherein the time-series image data includes time-series spatial data that is processed by the primary RNN to extract spatio-temporal features.

3. The system of claim 2, wherein the spatio-temporal features are processed using the secondary RNN to generate one or more future state predictions, and wherein the one or more generated future state predictions are processed by the second neural network to generate model space attribute grids.

4. The system of claim 1, wherein the model space representation is a three-dimensional (3D) model space that comprises a bird's eye view raster.

5. The system of claim 1, wherein the primary and secondary RNNs are linked.

6. The system of claim 1, wherein the secondary RNN generates predictions in a different coordinate system than the primary RNN processes information from.

7. The system of claim 1, wherein the primary RNN and the secondary RNN each comprise one of a convolutional recurrent neural network (CRNN), a convolutional gated recurrent unit (CGRU), and a convolutional long short-term memory (CLSTM).

8. The system of claim 7, wherein the primary and secondary RNNs form a coupled CLSTM (CCLSTM) module having primary and secondary CLSTM cells, and wherein the secondary CLSTM cell predicts at any integer multiple of the frame rate at which the primary CLSTM cell aggregates.

9. The system of claim 8, wherein the control system or a separate computing system is further configured to train the coupled CLSTM module.

10. The system of claim 1, wherein the vehicle control decision includes the control of a driver assistance or autonomous driving system based on the evaluation at least one of ego-vehicle and exo-vehicle trajectories based on the attribute grids.

11. A method for predicting a distribution of possible future object locations and associated attributes of objects surrounding a vehicle, the method comprising:
obtaining, by a set of one or more perception sensors of the vehicle, sensor data that includes at least time-series image data;
processing, by a control system of the vehicle, the sensor data using a first neural network to fuse the sensor data and extract spatial features from the sensor data;
processing, by the control system, the time-series image data using a primary recurrent neural network (RNN) to extract temporal features from the time-series image data;
generating, by the control system, one or more future temporal features using a secondary RNN;
applying, by the control system, a second neural network to the future temporal features to decode them into a model space representation, wherein the model space representation includes at least object occupancy and motion flow; and
processing, by the control system, the model space representation to utilize it for at least one of controlling and influencing a vehicle control decision including at least one of ego-vehicle trajectory evaluation and exo-vehicle trajectory retrieval.

12. The method of claim 11, wherein the time-series image data includes time-series spatial data that is processed by the primary RNN to extract spatio-temporal features.

13. The method of claim 12, wherein the spatio-temporal features are processed using the secondary RNN to generate one or more future state predictions, and wherein the one or more generated future state predictions are processed by the second neural network to generate model space attribute grids.

14. The method of claim 11, wherein the model space representation is a three-dimensional (3D) model space that comprises a bird's eye view raster.

15. The method of claim 11, wherein the primary and secondary RNNs are linked.

16. The method of claim 11, wherein the secondary RNN generates predictions in a different coordinate system than the primary RNN processes information from.

17. The method of claim 11, wherein the primary RNN and the secondary RNN each comprise one of a convolutional recurrent neural network (CRNN), a convolutional gated recurrent unit (CGRU), and a convolutional long short-term memory (CLSTM).

18. The method of claim 17, wherein the primary and secondary RNNs form a coupled CLSTM (CCLSTM) module having primary and secondary CLSTM cells, and wherein the secondary CLSTM cell predicts at any integer multiple of the frame rate at which the primary CLSTM cell aggregates.

19. The method of claim 18, wherein the control system or a separate computing system is further configured to train the coupled CLSTM module.

20. The method of claim 11, wherein the vehicle control decision includes the control of a driver assistance or autonomous driving system based on the evaluation of at least one of ego-vehicle and exo-vehicle trajectories based on the attribute grids.
